(19) United States
(12) Patent Application Publication
(10) Pub. No.: US 2016/0227721 A1
(43) Pub. Date: Aug. 11, 2016

(54) HYDROPONICS SYSTEM

(71) Applicant: Botany Unlimited Design & Supply LLC, Pasco, WA (US)

(72) Inventor: Mark Gomez, Pasco, WA (US)

(21) Appl. No.: 15/041,364

(22) Filed: Feb. 11, 2016

Related U.S. Application Data
(60) Provisional application No. 62/114,981, filed on Feb. 11, 2015.

(51) Int. Cl. A01G 31/02

(52) U.S. Cl. CPC A01G 31/02

(57) ABSTRACT

A modular hydroponics system for growing plants includes a frame or framework of one or more cages, wherein each cage preferably includes, a source of electrical power and water, at least one moveable light source and at least one moveable circulating fan. Plants are arranged on benches in ebb & flow containers in a stadium arrangement. A mechanism moves the light source along the benches and a reflective hood directs light to the plants. The fan circulates air to control the air temperature within the framework. A watering system supplies and collects water to and from the plants. The pH and nutrient levels in the water is monitored and controlled.

### PRIORITY CLAIM

This application claims priority to U.S. Provisional Patent Application No. 62/114,981 filed on Feb. 11, 2015. The foregoing application is herein incorporated by reference in its entirety.

### COPYRIGHT NOTICE

This disclosure is protected under United States and International Copyright Laws. ©2012-2014 Emerald Ventures, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to large scale or commercial horticultural systems and in particular to systems for cultivating plants using soil-less techniques such as hydroponics.

### BACKGROUND OF THE INVENTION

Hydroponics has been defined as one example of the soilless culture in which mineral nutrient solutions are utilized for crop growth. Such systems allow for more controlled utilization of nutrients than traditional soil-based techniques. Environmental factors, such as temperature, evaporation and light affect system efficiencies and plant growth. Accordingly, there is a need for a hydroponics system that provides improved operational efficiency and plant yield.

### BRIEF DESCRIPTION OF THE DRAWINGS

Preferred and alternative examples of the present invention are described in detail below with reference to the following drawings:

FIG. 1 is a schematic diagram of a hydroponics system according to a preferred embodiment of the present invention;

FIG. 2 illustrates various aspects of the system of FIG. 1;

FIG. 3 illustrates still further aspects of the system of FIG. 1;

FIG. 4 depicts a light source suitable for use in the system of FIG. 1;

FIG. 5 depicts portions of the plumbing and water system for the system of FIG. 1;

FIG. 6 illustrates stadium arrangement of benches for the system of FIG. 1;

FIG. 7 illustrates the use of curtains for the system of FIG. 1; and,

FIG. 8 illustrates a seed bed according to an alternative embodiment of the present invention.

### DETAILED DESCRIPTION OF THE PREFERRED EMBODIMENT

Hydroponics is a soil-less technique for growing plants. An advantage of hydroponics over conventional soil-based techniques is that the growing environment can be better controlled, including for example, the nutrient levels provided to the growing plants, the water provided to the plants can be readily retained in the system providing significant water savings and/or minimizing the risk of mold development, and the energy expended by the system can be more efficiently utilized.

Devices for cultivating plants using hydroponic techniques typically comprise a table and a water pool in which plants are suspended from a rack so that the roots are exposed to a nutrient solution wherein the water is pumped into the pool of water and back out, e.g. using an ebb and flow technique.

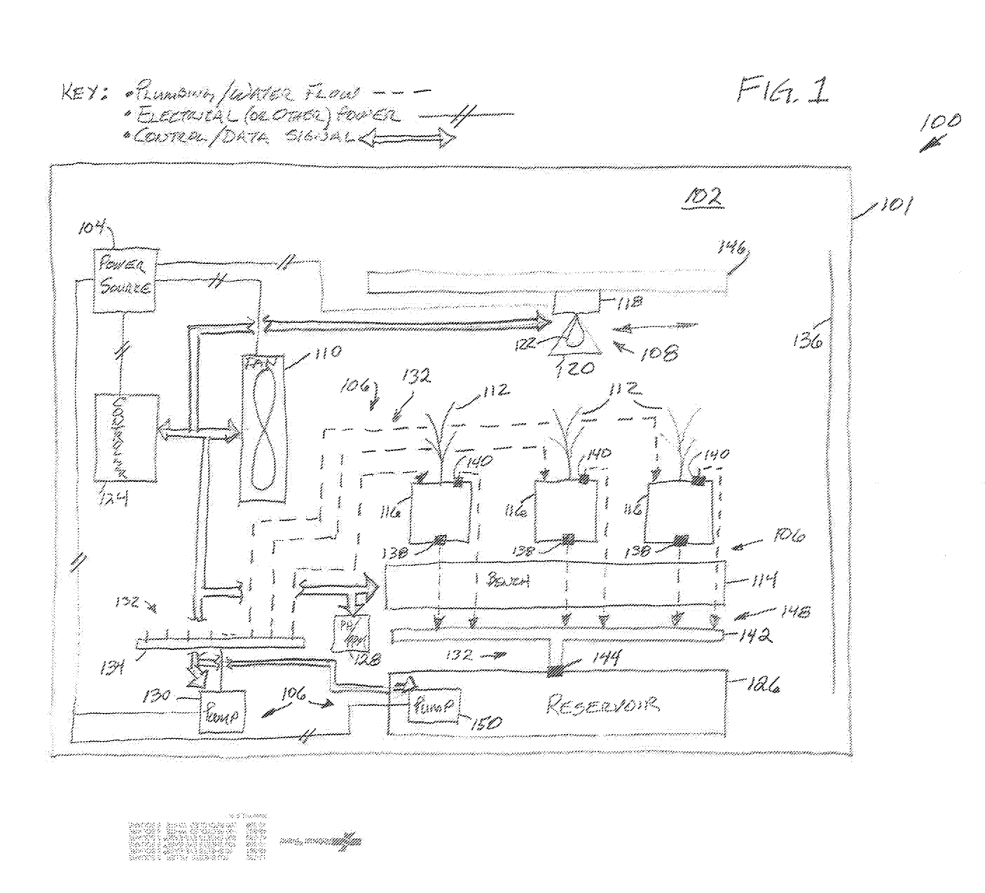

FIG. 1 illustrates a modular hydroponics system 100 according to a preferred embodiment of the present invention. System 100 preferably includes a frame or framework 101 of one or more cages 102. For ease of understanding, a single cage 102 is illustrated in FIG. 1. It is, however, understood as discussed herein, that system 100 may comprise more than one cage 102. Cage 102 preferably includes a source of electrical power 104, water system 106, at least one, preferably moveable, light source 108 and at least one circulating fan 110. Plants 112 are arranged on one or more benches 114 in ebb & flow containers 116 in a stadium arrangement (not shown in FIG. 1). Light source 108 preferably moved by mechanism 118 moves along the benches 114 and a reflective hood 120 precisely directs light from a lamp 122 to the plants 112. The fan 110 circulates air to control the air temperature within a cage 102. The watering system 106 supplies and collects water to and from the plants. The pH and nutrient levels (not shown in FIG. 1) in water system 106 are monitored and controlled by controller 124. Controller 124 may also provide various levels of control to other components of system 100, including the power supply 104, light source 108, fan 110 and water system 106. Controller 124 may, for example, but without limitation, be in the form of a centralized control panel or as various distributed controllers and monitors throughout system 100 offering various degrees of control and automation.

The hydroponics system according to the present invention is well suited for large-scale commercial applications and provides improved system efficiencies and plant quality (yield). For example, plant growth is accelerated and the consistency and quality of plants 112 is improved through use of the hydroponics system 100 of the present invention. Further, by way of example, energy, water and nutrients are more efficiently utilized through use of the hydroponics system 100.

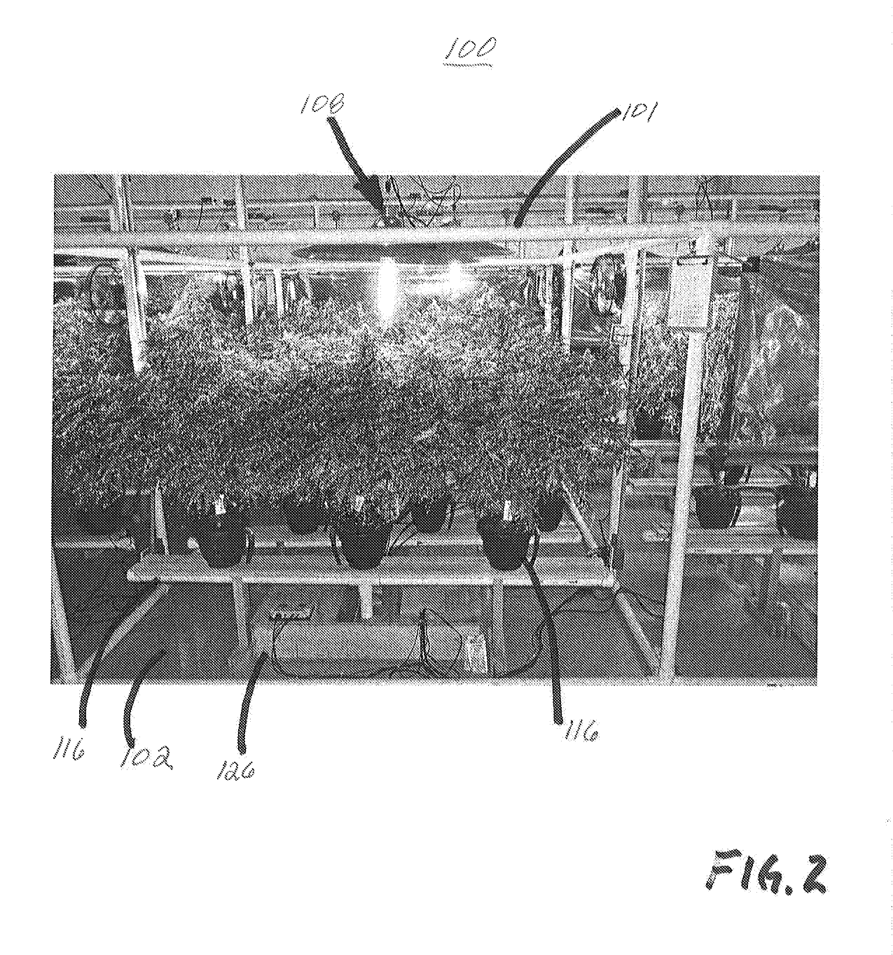

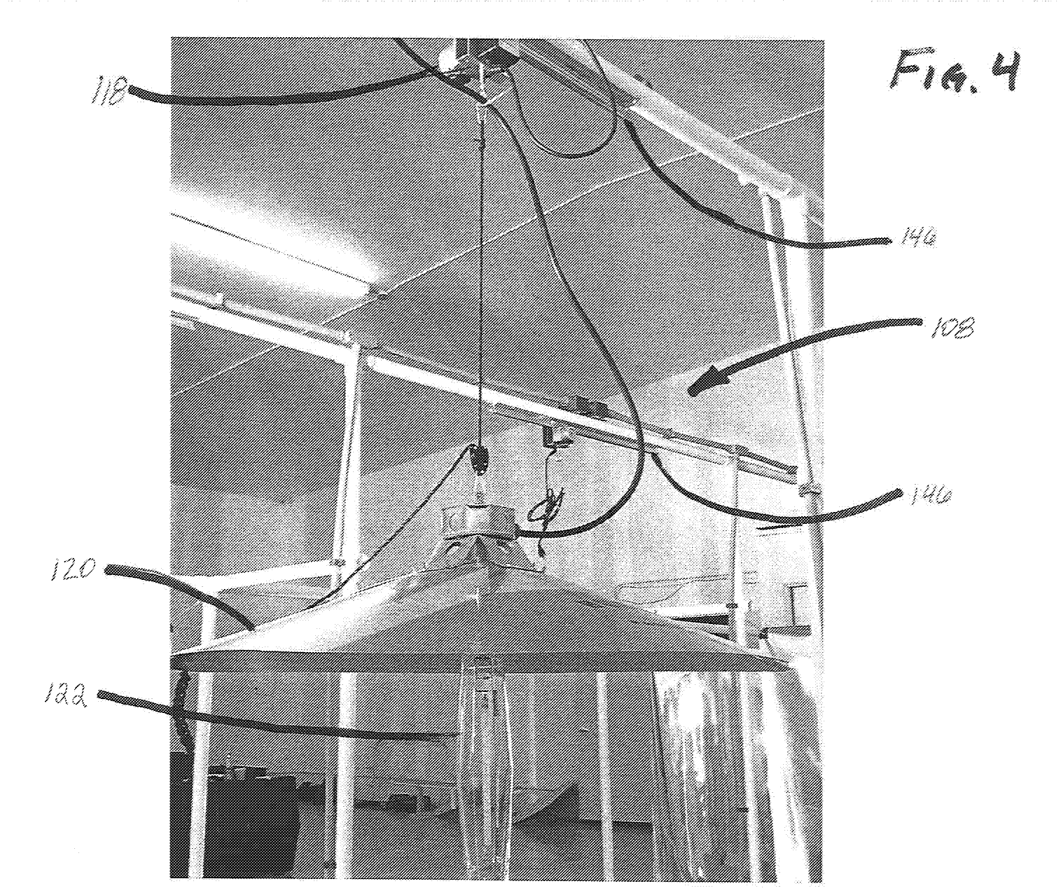

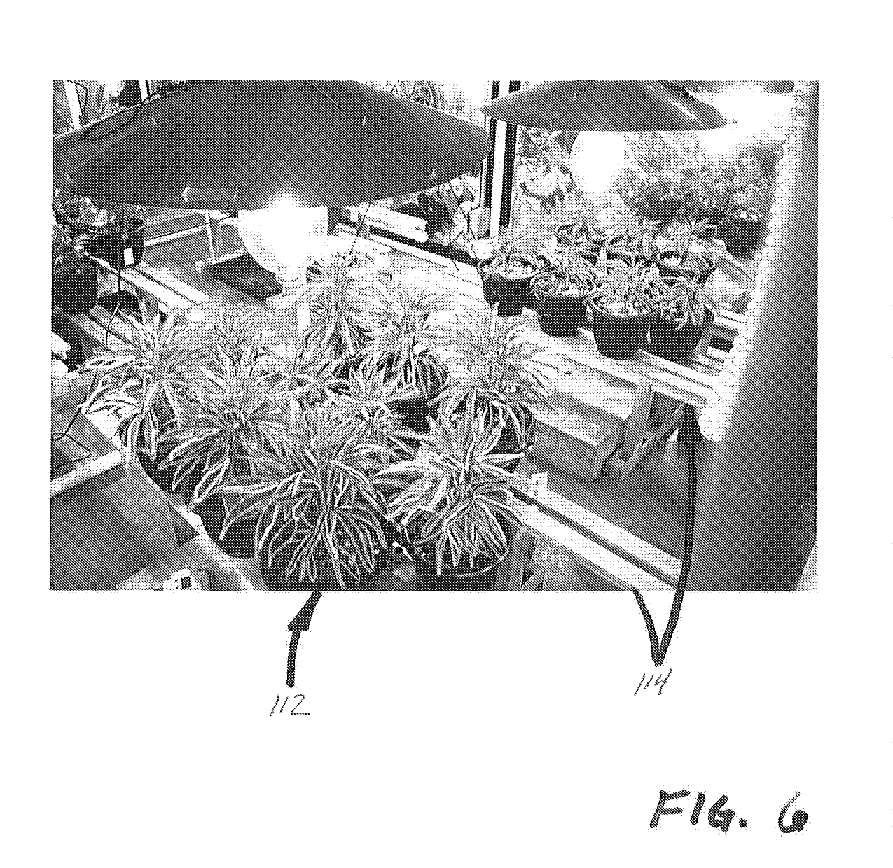

As previously discussed and represented in FIG. 1 and further illustrated in FIGS. 2-7, system 100 is preferably modular and may comprise a frame or framework of one or more cages 102, wherein each cage preferably includes, by way of example, a power supply 104, 6 benches 114, 2 light sources 108, 2 axial fans 110, water system 106, 20 plants 112 in 20 ebb and flow containers 116 and controller 124. Water system 106 includes one or more each of a reservoir 126, circulating pump 130, plumbing 132 and manifold 134. Water system 106 also preferably includes nutrient controllers 128 for monitoring and/or controlling nutrient levels in the water. Nutrient controllers may, for example, be PH/PPM meters. Light source 108, preferably includes a 1000 watt lamp 122, a mechanism 118 (such as a motors) for moving the light source 108 and a device 120 for directing the light from lamp 122 (FIG. 4). Light directing device 120 may, for example, be a reflective hood or prismatic lens to aid in efficiently directing the light output to the plants 112. It is understood that the number and mixture of components of a cage, as exemplarily illustrated above, may be changed, increased or reduced to satisfy user-specific needs. For example, the number of the above-noted components in each cage could be increased for very large scale commercial operations. Similarly, the number of cages could be increased or reduced to meet specific user needs. Similarly, reducing the number of components in a cage, say for example by half, may make a cage suitable for small scale operations such as home or personal use.

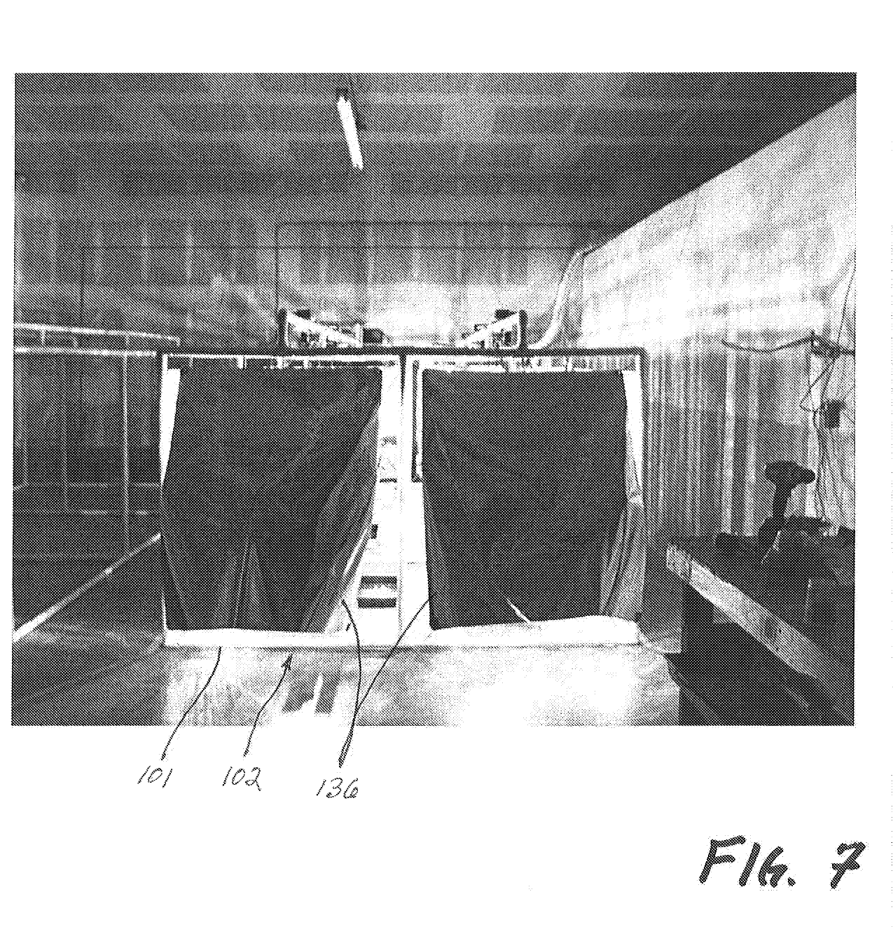

Cage 102, according to one embodiment, is constructed from PVC tubing (FIG. 2) and includes reflective curtains 136 (FIG. 7) to improve energy efficiency of the system by redirecting energy to the plants, thereby reducing system energy loss. The reflective curtains 136 may, for example, comprise Mylar® sheets attached to some or all of the sides and ends of the cage(s) 102. The Mylar® is preferably removably attached to cages with, for example, rubber bands or other nonconductive material that further help in minimizing heat transfer, and thereby further improve system efficiency. The cages 102 along with the reflective curtains 136 form a micro-environment for the plants 112.

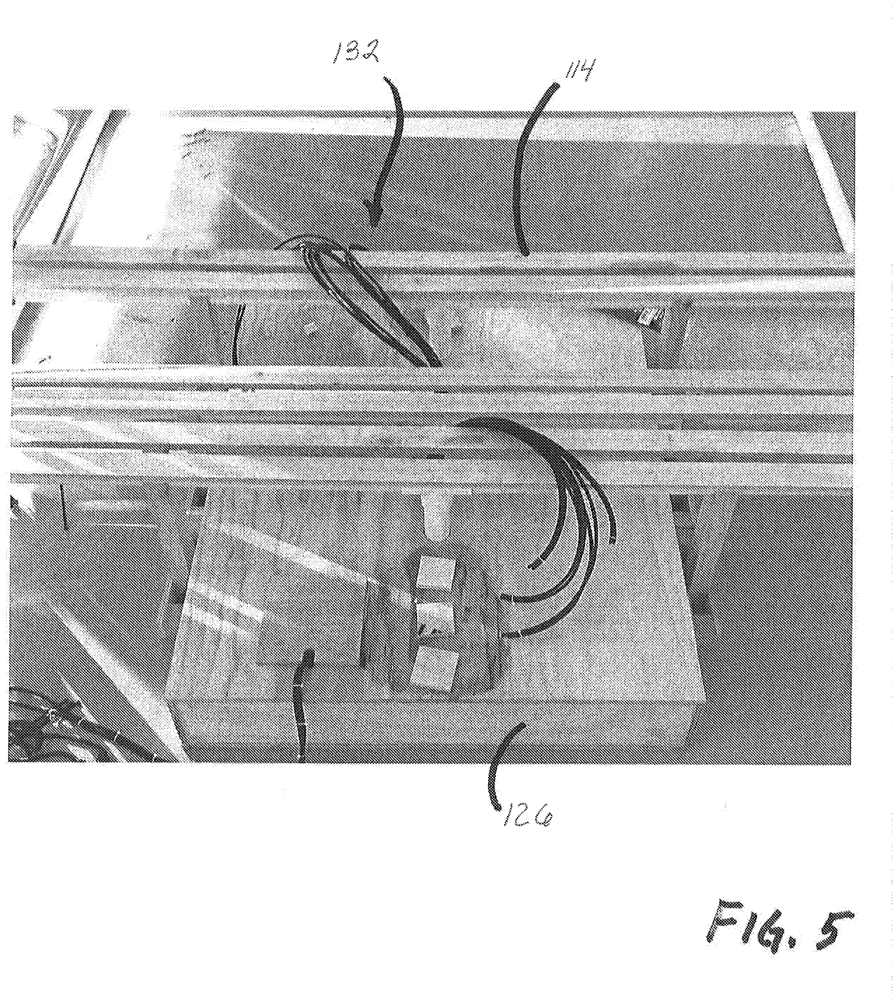

As previously discussed and illustrated in FIG. 1, each cage 102 preferably incorporates a power source 104, such as for example, one or more GFI outlets for supplying electricity to light sources 108 and fans 110 within the cage 102. Individual ebb and flow containers (pots) 116 sit on benches 114 with flow tubes (plumbing) 132 (FIG. 5) going to each container. In accordance with one embodiment, each ebb and flow container 116 contains a plant 112 that is being grown with the hydroponics system of the present invention. A drain 138 on the ebb and flow containers 116 is restricted so the incoming nutrients drain slower than they fill, allowing the water level to reach an overflow 140 at the top of each container 116. Utilizing gravity, both the drain 138 and/or overflow 140 are discharged into a PVC drain tube 142 under each bench 114. This in turn, preferably directs the flow of all the containers 116 on a single bench 114 to one drain hole 144 in the top of the reservoir, providing a substantially closed-loop system enhancing overall system efficiency.

Each light source moving mechanism 118 shuttles a light source 108 back and forth in line preferably with the center one of three substantially parallel benches 114 located over each reservoir 126. The light source moving mechanism 118 may be an electric motor or other actuator positioned on a rail or track 146 positioned above the benches 114 and is preferably powered by the power source 104. The power source 104 may also be nonelectrical, such as for example pneumatic or hydraulic with the motor or actuator powered accordingly. The motion allows the lamp 122 of the light source 108 to be positioned closer to the plants (i.e., closer than if the light source 108 were stationary) without delivering excessive energy to the plant 112, resulting in a more efficient use of the light source 108 while reducing the risk of burning or otherwise damaging the plants 112. Reflective hoods 120 in each light source 108 are positioned above the lamp 122 (relative to the plant 112) to reflect and direct energy (e.g., light) to the plant, further increasing system efficiency.

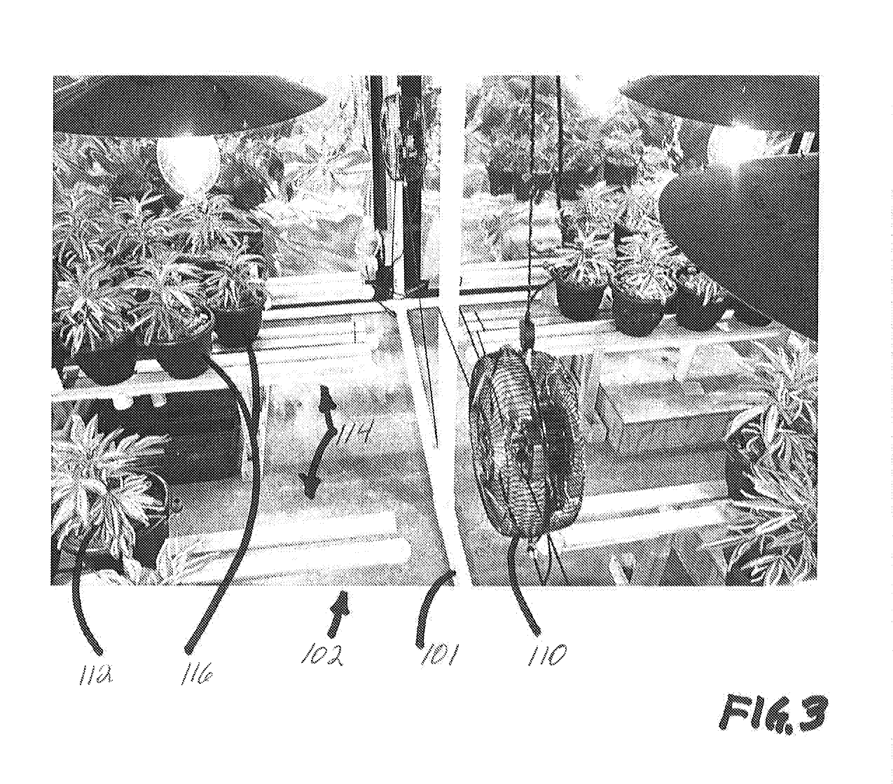

The axial fans 110 may be connected to the same power source 104 as the light sources 108 in a particular cage 102 and may either be coupled to the rail or track 146 and move with the light source 108 or be stationary within the cage 102 (FIG. 3). The fans 110 are preferably mounted vertically on the cage at substantially the same level as the lamp 122, blowing cool air around the lamp and heating the air in motion while cooling the lamp 122 and/or reflective hood 120. According to one embodiment, the lamps 122 are 1000 watt metal halide, but it is understood that other wattages and types of lamps may be used in the system of the invention and that other modifications to various elements and their arrangements within the system may be required in order to provide system efficiencies.

As represented in FIG. 1 and further illustrated in, for example, FIG. 5, the reservoirs 126 sit below the benches 114. Each reservoir 126 preferably includes a pump 130 and/or manifold 134 to deliver water to each ebb and flow container 116. The manifold 134 is designed to deliver the same flow rate (i.e., the same amount of water at the same time and/or pressure) to each of the ebb and flow containers 116. The water passes through the containers 116 containing the plants and into a trough 148. Trough 148 may be positioned within or under each bench 114. Gravity returns the liquid (e.g., water plus nutrients) back to reservoir 126. In accordance with a preferred embodiment of the present invention, each reservoir 126 includes an additional circulation pump 150, which stirs the reservoir 126 when desired and/or during the plant watering process.

According to a preferred embodiment of the present invention system efficiencies are enhanced as water evaporation is reduced and more light is allowed to reach each plant 112, thereby increasing the efficient use of resources and expending the least amount of energy. Preferably, the ebb and flow containers 116 fill and stop automatically when watering, and each individual container 116 can be moved about the bench 114 as needed. As a result water and light are better utilized, through less evaporation and optimizing plant locations relative to the lighting, respectively.

In accordance with a preferred embodiment, benches are arranged in groupings of three (3) and are generally parallel to one another in a “stadium” arrangement, whereby the middle bench is lower in elevation than the two outer benches (best depicted in FIGS. 2, 3, 6). The lengths of the benches are generally in line with the movement of the light sources discussed above. This arrangement allows the light fixture associated with a group of three benches to move along their length and efficiently provide light to plants situated on the benches.

As previously introduced, each reservoir 126 preferably has an instrument or device for monitoring and/or controlling the chemistry of the fluid in the system (nutrient controller 128). For example, each reservoir 126 may have a PH/PPM meter for monitoring PH and nutrient levels of the circulating water. The devices may provide readouts for personnel to monitor or, alternatively, they may provide output signals to controllers 124 in the system 100 that automatically control the PH and nutrient levels.

In accordance with further aspect of the present invention, the reflective hoods 120 of the light sources 108 are mounted vertically around the lamps 122 and are designed to direct light and dissipate heat from the lamps 122 (FIG. 4). In accordance with a preferred embodiment, the hoods 120 are designed to accommodate stadium-arranged benches 114. That is, for example, three (3) rows of plants 112 with four (4) plants 112 in the center row and three (3) plants 112 in each outside row. Preferably, the tallest plants are placed in the outer rows, shortest plants in the center row in order to maximize light use. This diamond pattern placement of plants 112 allows more light from the lamp 122 to strike the plants (i.e., reduces the amount of light hitting the floor) and thereby further enhances system efficiency.

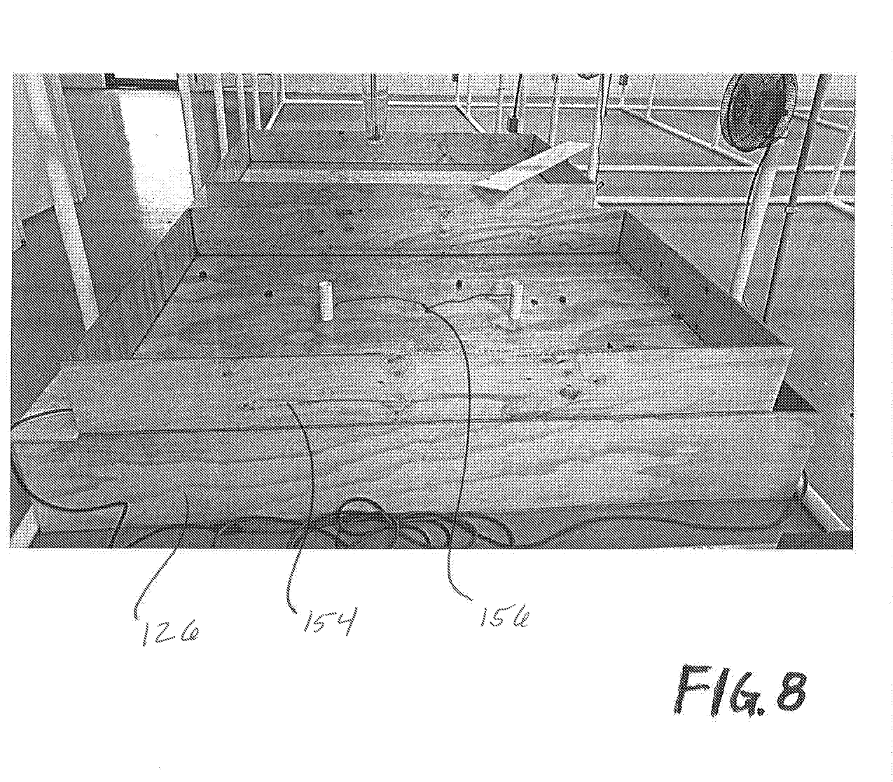

In accordance with a further embodiment of the present invention, FIG. 8 illustrates a seed bed 154 used in system 100. Seed bed 154 is position above the reservoir 126 and replaces ebb and flow containers 116. Water and nutrients are pumped from the reservoir into the seed bed 154 via drain fittings placed in the bottom of the seed bed. Water overflow from the seed bed is prevented by overflow drains 156 placed preferably in the center of the seed bed 154. Further operation and functionality are as set forth and described herein.

While the preferred embodiment of the invention has been illustrated and described, as noted above, many changes can be made without departing from the spirit and scope of the invention. For example, as previously noted, different light sources may be used and may require modifications to other elements, such as size, location and orientation of fans, reservoirs, manifolds, to name a few. Also, it may be possible to vary the stadium arrangement of the benches to accommodate other modifications to the preferred embodiment, such as, for example, the number of plants and light sources used with each particular group of benches. The cages may be constructed with various materials other than PVC, such as other non-heat conducting materials, or even using conductive materials that are insulated to prevent unintended heat loss or transmission. Further, many of the elements and functions of the system of the present invention, may be controlled manually, automatically, or a combination of both. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A hydroponics system for growing plants comprising:
a cage having a frame;
a plant support structure within the cage for supporting one or more plants;
a water system coupled to the plant support structure for supplying water to the one or more plants; and,
a light source within the cage for providing light to the one or more plants.

2. The system of claim 1, wherein the plant support structure comprises a plurality of benches for supporting the plants.

3. The system of claim 2, wherein the plurality of benches comprises at least 3 benches substantially parallel to one another.

4. The system of claim 3, wherein a center bench is lower than outer benches.

5. The System of claim 1, wherein the plant support structure comprises an ebb and flow system.

6. The system of claim 5, wherein the ebb and flow system comprises a container for each plant.

7. The system of claim 6, wherein the water system provides controlled watering to the one or more plants.

8. The system of claim 7, wherein the water system includes a manifold coupled to a reservoir for supplying the controlled watering to the one or more plants.

9. The system of claim 3, wherein the light source is moveably oriented above the three substantially parallel benches so that the light source moves substantially parallel to the benches.

10. The system of claim 1, further comprising a reflective curtain coupled to the frame for controlling environmental conditions within the cage.

11. A hydroponics system for growing plants comprising;
a cage having a frame;
a plant support structure within the cage for supporting one or more plants;
a substantially closed-loop water system for supplying water to the one or more plants; and, p1 a light source within the cage for providing light to the one or more plants.

12. The system of claim 11, wherein the substantially closed-loop water systems comprise:
a reservoir; and,
a pump coupled to the reservoir for supplying water to the one or more plants.

13. The system of claim 12, wherein the water system further comprises a manifold coupled to the pump for supplying controlled flow to the one or more plants.

14. A modular hydroponics system for growing plants comprising having a plurality of interconnected cages, wherein each cage comprises:
a frame;
a plant support structure for supporting one or more plants;
a water system coupled to the plant support structure for supplying water to the one or more plants; and,
a light source for providing light to the one or more plants.

15. The system of claim 14, further comprising a reflective curtain coupled to the frame for controlling environmental conditions within each cage.
